(19) United States
(12) Patent Application Publication
(10) Pub. No.: US 2018/0016487 A1
(43) Pub. Date: Jan. 18, 2018

(54) Process of providing a viscosified water for injecting into an underwater subterranean oil bearing formation and associated underwater facility

(71) Applicant: TOTAL SA, Courbevoie (FR)

(72) Inventors: Kalid Mateen, Katy, TX (US); Philippe Cordelier, Idron (FR); Alexandre Goldszal, Etang La Ville (FR); Stéphane Jouenne, Bizanos (FR)

(21) Appl. No.: 15/541,989

(22) PCT Filed: Jan. 6, 2015
(86) PCT No.: PCT/IB2015/000147

§ 371 Date: Aug. 2, 2017

(51) Int. Cl. C09K 8/588; C09K 8/584; C02F 1/44; C02F 1/38; E21B 43/20; B01D 61/58; C02F 103/08; B01D 61/14; B01D 61/02

(52) U.S. Cl. CPC C09K 8/588; E21B 43/20; C09K 8/584; C02F 1/441; B01D 61/58; C02F 1/38; C02F 1/442; C02F 1/444; B01D 61/145; B01D 61/025; B01D 61/027; B01D 2311/2676; C02F 2103/08

(57) ABSTRACT

The underwater process comprises the following steps, carried out underwater, at the bottom of a body of water: providing a base fluid (38) comprising at least a viscosifying compound, obtaining a concentrated viscosifying solution (34) from the base fluid (38), providing a processed water of controlled salinity (36), diluting the concentrated viscosifying solution (34) with the processed water of controlled salinity (36) to form the viscosified water (32).

The present invention relates to a process of providing a viscosified water into an offshore oil bearing formation.

The process is intended in particular for preparing viscosified water for injecting into a subterranean oil bearing formation, at the bottom of a body of water. The injection allows an improved microscopic and macroscopic displacement of the oil present in the formation leading to enhanced oil and gas recovery.

To enhance oil recovery, it is known to inject into the well a viscosified water having a controlled viscosity, in order to decrease the mobility ratio between water and oil in the formation.

To this aim, a solution with a high concentration of a water-based viscosifying polymer is prepared from powder or from emulsion polymer. Then, the solution is diluted with a processed water of controlled salinity, prepared for example from sea water.

The resulting mixture is injected under pressure in the formation. The injection in the wells of a production installation generally requires large volumes of viscosified water, e.g. in the order of several thousands of tons per day.

US 2012/125611 discloses a process of preparation of viscosified water. Such a preparation process is adapted for an onshore environment. However, in an offshore environment, the implementation of such a process raises several challenges.

First of all, the logistics of providing base materials such as polymer powder and/or emulsion, and processed water can be difficult to handle and often requires a significant facility to be set up on or close to the production area.

In particular, given the large volume of viscosified water which must be prepared, a high capacity preparation facility is needed, which results in high capital cost. The preparation facility indeed occupies a large footprint on the production vessel or requires a different floating assembly to be set in place in the vicinity of the production vessel.

Moreover, the polymer solution is very sensitive to oxygen. Stringent precautions must be taken to avoid the chemical degradation of the polymer solution, due to the presence of oxygen.

Additionally, in deep offshore environments, the viscosified water prepared on the topsides needs to be transported to long distances and large depths. The viscosified water may therefore undergo mechanical degradation and shear, which may result in a loss of viscosity. The quantity of polymer necessary to prepare the solution must then be increased, which adds to the cost of the operation. Overall, the cost of the preparation and injection in this process may therefore become prohibitive for offshore environment.

An object of the invention is to obtain a process which provides viscosified water in in an efficient and economically viable manner.

To this aim, the subject-matter of the invention is an process of the type mentioned above, comprising the following steps, carried out underwater, at the bottom of a body of water:
providing a base fluid comprising at least a viscosifying compound;
obtaining a concentrated viscosifying solution from the base fluid;
providing a processed water of controlled salinity;
diluting the concentrated viscosifying solution with the processed water of controlled salinity to form the viscosified water.

The underwater process according to the invention may comprise one or more of the following feature(s), taken alone or according to any technical possible combination:
the viscosifying compound comprises a polymer and/or a surfactant.
the base fluid is provided from above the surface of the body of water.
the base fluid consists of an emulsion, the preparation step comprising breaking the emulsion at the bottom of the body of water to form the concentrated viscosifying solution.
the emulsion comprises diluting the base solution.
the base fluid consists of a water in oil emulsion, the viscosifying compound being contained in the water phase of the water in oil emulsion.
the base fluid consists of a concentrated solution of the viscosifying compound.
the step of providing a processed water of controlled salinity comprises generating, at the bottom of the body of water, a water with controlled ion concentration, in particular controlled divalent ions concentration.
the water generation step comprises passing a source water in a disc filtration unit, a hydrocyclone, an ultrafiltration unit, a nanofiltration unit, and/or a reverse osmosis unit.
the underwater process comprises storing a base fluid into a pressure compensated tank and/or a pressure rated tank at the bottom of the body of water, the concentrated viscosifying solution being prepared from the base fluid contained in the tank.
the diluting step comprises passing the mixture of processed water of controlled salinity and of concentrated viscosifying solution into a mixing device.
the underwater process comprises injecting the viscosified water into the underwater subterranean formation.
the viscosity of the viscosified water at the injecting step is comprised between 1 mPa·s and 50 mPa·s.

The invention also concerns an underwater facility providing a viscosified water for injecting into an underwater subterranean oil bearing formation, comprising:
a stage for obtaining a concentrated viscosifying solution from a base fluid comprising at least a viscosifying compound;
a stage for providing a processed water of controlled salinity;
a stage for preparing a viscosified water, comprising a mixing device for diluting the concentrated viscosifying solution with the processed water of controlled salinity to form the viscosified water.

The installation according to the invention may comprise one or more of the following technical features, taken alone or according to any technically possible combination:
the stage for obtaining a concentrated viscosifying solution comprises a source of a base fluid being an emulsion, and comprising a module for breaking the emulsion located upstream of the mixing device.
the stage for obtaining a concentrated viscosifying solution comprises a pressure compensated tank or a pressure rated tank containing a base fluid intended to form the concentrated viscosifying solution.
the stage for providing a processed water of controlled salinity comprises a disc filtration unit, a hydrocyclone, a ultra-filtration unit, a nanofiltration unit and/or a reverse osmosis unit.
the underwater facility comprises a stage for injecting the viscosified water into the underwater subterranean formation.

The invention will be better understood, upon reading of the following description, given solely as an example, made in accordance with the following drawings, in which:

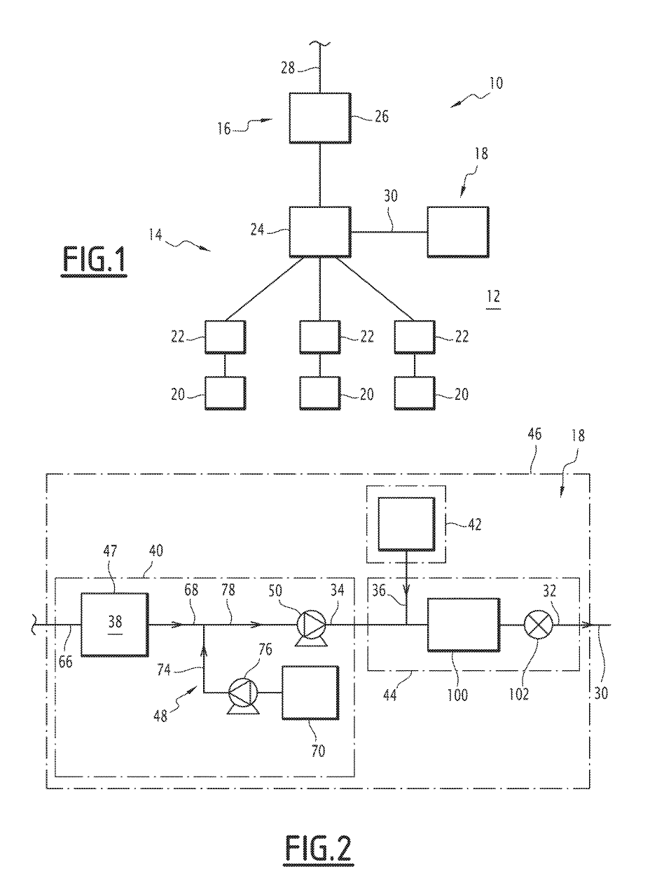

FIG. 1 is a schematic diagram of an underwater portion of an oil and gas production installation according to the invention;

FIG. 2 is a schematic diagram of a first underwater facility for providing viscosified water in a underwater subterranean formation, according to the invention;

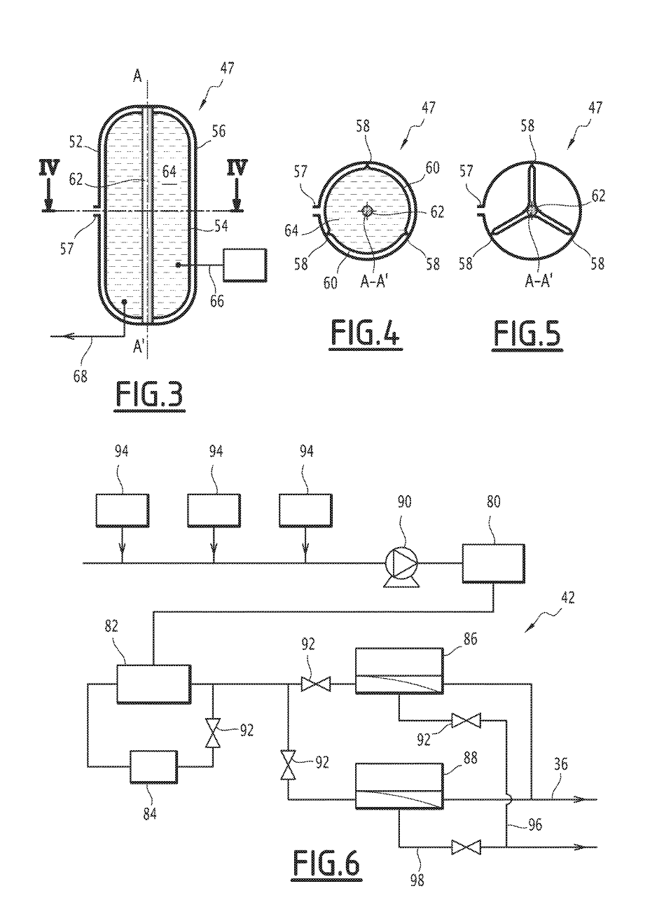

FIG. 3 is a cross-sectional view, taken along a longitudinal axis, of a storage tank for a base fluid containing polymer;

FIG. 4 is a view, taken along lines IV-IV, of the tank of FIG. 3, when the tank is almost full;

FIG. 5 is a view similar to FIG. 4, when the tank is almost empty;

FIG. 6 is a schematic view of an example of a stage for providing a processed water of controlled salinity;

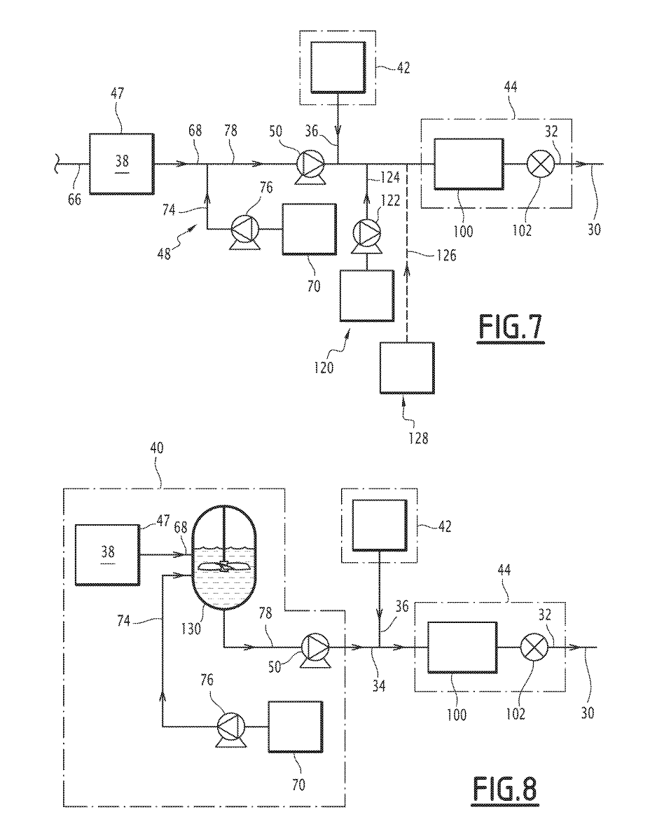

FIG. 7 is a view similar to FIG. 2 of a second underwater facility according to the invention.

FIG. 8 is a view similar to FIG. 2 of a third underwater facility according to the invention.

The underwater portion of a first oil production installation 10 according to the invention is shown schematically in FIG. 1.

The installation 10 is intended for recovering a fluid, in particular a hydrocarbonaceous fluid such as oil in a underwater subterranean formation located under a body 12 of water, and to convey the oil towards the surface of the body of water 12.

The installation 10 comprises a bottom recovery facility 14 located at the bottom of the body of water, a surface facility (not shown on FIG. 1) and a fluid transport assembly 16 connecting the bottom recovery facility 14 with the surface facility.

According to the invention, the installation 10 further comprises an underwater facility 18, located at the bottom of the body of water for providing viscosified water in a underwater subterranean formation, connected to the bottom recovery facility 14.

The bottom recovery facility 14 comprises one or more wells 20 bored in the subterranean formation from the bottom of the body of water 12 to reach an oil bearing formation (not shown).

The facility 14 further comprises, for each well 20, a well head 22 selectively closing the well 20, and at least a manifold 24 connected to one or several wells 20 to recover the oil collected in each well 20.

The transport assembly 16 advantageously comprises a collector 26 connected to each manifold 24 and at least one riser 28 connecting the collector 26 to the surface facility.

The underwater facility 18 is immersed in the body of water 12. It advantageously rests on the bottom of the body of water 12, in the vicinity of the bottom recovery facility 14.

The underwater facility 18 is connected to each well 20, advantageously through the manifold 24 or through a specific manifold, by an injection pipe 30.

The underwater facility 18 is able to produce a viscosified water for injection into the underwater oil bearing formation.

The viscosified water preferentially has a viscosity ranging from 1 mPa·s to 50 mPa·s, in particular from 3 mPa·s to 10 mPa·s. This viscosity is measured at ambient temperature.

The viscosified water comprises at least one viscosifying compound, preferentially a water soluble polymer. The viscosifying polymer is for example a derivative of a polyacrylic acid, such as polyacrylamide. In particular, the polymer is a hydrolyzed polyacrylamide (HPAM). In a variant, the polymer comprises a gum, such as xanthan gum, or a polymer designed so as to withstand high temperatures (for example 120° C.), and high salinity (up to 240 g/l).

The polymer mass content is adjusted to obtain the required viscosity. Advantageously, the mass content of polymer into the viscosified water is comprised between 1,000 ppm and 5,000 ppm, in particular between 1,000 ppm and 3,000 ppm.

The molecular weight of the polymer is greater than 10×10⁶ g/mol and is advantageously comprised between 10×10⁶ g/mol and 20×10⁶ g/mol.

Advantageously, the viscosified water has a controlled content in dissolved ions, in particular a controlled content in divalent ions.

The total mass content in dissolved ions in the viscosified water is generally less than 15% and is for example comprised between 5% and 13%.

The divalent ions are for example cationic, e.g. alkaline earth metals ions such as calcium or magnesium or/and strontium ions. In a variation, the divalent ions are anionic, for example sulfates and persulfates.

In a variation, the viscosified water further comprises one or several surfactants, such as anionic, cationic and/or nonionic surfactants. It may comprise one or more alkalis, such as a carbonate, or ammonia.

According to the invention, the viscosified water is prepared in the underwater facility 18 below the surface of the water from a concentrated solution 34 which is mixed with a processed water of controlled salinity 36 to reach the appropriate viscosity.

In the present embodiment, the concentrated solution 34 is prepared from a base fluid 38, consisting of an emulsion, preferentially a water in oil emulsion containing the viscosifying polymer in the water phase. The emulsion is broken by dilution in water, and/or by addition of at least a chemical to obtain the concentrated solution.

Accordingly, in reference to FIG. 2, the underwater facility 18 comprises a stage 40 for preparing the concentrated solution 34 from the base solution 38, a stage 42 for providing the processed water of controlled salinity 36, and a stage 44 for preparing and injecting the viscosified water 32 obtained by diluting the concentrated solution 34 with the processed water of controlled salinity 36.

The underwater facility 18 is totally immersed in the body of water 12 under the surface of the body of water 12, preferentially at the bottom of the body of water 12. It is for example supported in a modular rack 46 such as disclosed in French patent application no. 13 63 131 filed on Dec. 19, 2013.

As illustrated in FIG. 2, the stage 40 for preparing a concentrated viscosifying solution 34 comprises a pressurized tank 47 for storing the base fluid 38 consisting of a water-in-oil emulsion, and a module 48 for breaking the water-in-oil emulsion. In a variant, the tank 47 is a pressure fully rated tank.

The stage 40 further comprises a mixing pump 50, located downstream of the module 48.

An example of pressurized tank 47 is illustrated in FIGS. 3 to 5. The pressurized tank 47 comprises an outer enclosure 52 intended to resist the pressure of the body of water 12 and an inner flexible enclosure 54, intended to deform under the pressure of water sampled from the body of water 12.

The inner enclosure 54 and the outer enclosure 52 define an intermediate space 56 able to receive water under pressure sampled from the body of water 12 through a flooding opening 57.

In this example, the inner enclosure 54 is fixed to the outer enclosure 52 at least along three vertical connection regions 58 visible in FIGS. 4 and 5. The walls 60 located between the regions 58 are able to deform radially towards a central axis A-A′ of the tank. In this example, a central reinforcement bar 62 is located at the central axis A-A′.

The inner enclosure 54 defines an inner variable volume 64 for receiving the base fluid 38.

In the configuration of FIG. 4, the inner volume is filled in with base fluid 38. The walls 60 are located relatively close to the outer enclosure 52. The inner volume 64 is maximal.

In the configuration of FIG. 5, the volume of base fluid 38 in the inner enclosure 54 is minimal. The pressure of the water introduced in the intermediate space 56 pushes the flexible walls 54 radially towards axis A-A′ and maintains the walls 54 relatively apart from the outer enclosure 52 and relatively close from one another. The inner volume 64 is minimal.

Advantageously, in the embodiment of FIG. 3, the inner volume 64 is fed batchwise or continuously in base fluid 38 through a feeding pipe 66 opening in the volume 64.

The inner volume 64 is connected to the module 48 through a distribution pipe 68.

In reference to FIG. 2, the module 48 comprises a source water volume 70, an outlet pipe 74 connected to the source water volume 70 and a dosing pump 76 whose outlet is connected to the distribution pipe 68.

The source water volume 70 is either a volume of sea water or a volume of processed water with a controlled amount of total dissolved ions.

The base fluid 38 advantageously contains a compound able to break the water in oil emulsion when the base solution 38 is diluted with source water. The compound is for example an inverting surfactant being dissolved in the water phase of the water in oil emulsion.

The dosing pump 76 is capable of conveying source water from the source water volume 70 to the outlet pipe 74 and to dilute the base solution 38.

The distribution pipe 68 and the outlet pipe 74 merge into a concentrated solution distribution pipe 78. The pipe 78 opens in an inlet of main distribution pump 50. The main distribution pump 50 distributes the concentrated solution 34 at a determined flow rate.

The stage 42 is intended to produce processed water of controlled salinity 36 with a controlled amount of total dissolved ions, and in particular a controlled amount of divalent ions.

An example of stage 42 is shown in FIG. 6. The stage 42 comprises at least a raw filtration unit 80, and an ultra-filtration unit 82 equipped with a backwash unit 84, downstream of the raw filtration unit 80. The stage 42 further comprises an ultra-filtration unit 82, and downstream of the ultra-filtration unit 82, a reverse osmosis unit 86 and a nanofiltration unit 88, mounted in parallel to produce the processed water of controlled salinity 36. In a variant, it also comprises hydrocyclones.

The stage 42 advantageously comprises at least a conveying pump 90, a number of control valves 92 and preferentially several pretreatment modules 94 including an oxygen scavenger injection unit, and an antiscalant unit.

The raw filtration unit 80 comprises for example a disc filter.

The ultrafiltration unit 82 and backwash tank 84 are for example of the type disclosed in WO 2014/044978. The ultrafiltration unit 82 comprises at least one ultra-filtration membrane. The pore size of the ultrafiltration membrane is usually a tenth of the particle size to be separated.

The reverse osmosis unit 86 comprises at least one reverse osmosis membrane able to retain at least part of the ions contained in the source water introduced in the unit 86 by reverse osmosis. It further comprises an evacuation line 96 for evacuating the retained ions enriched solution obtained from the passage through the membrane.

The nanofiltration unit 88 is able to selectively retain at least part the sulfate ions contained in the original source of water. It comprises at least a nano filtration membrane and an evacuation duct 98 for evacuating the recovered filtrate obtained from the passage through the membrane.

Units 86 and 88 are for example of the type disclosed in WO 2011/086346.

In reference to FIG. 2, the stage 44 comprises a mixing device 100 and a high pressure pump 102.

The mixing device 100 is for example a static mixer. It is connected upstream to the outlet of the mixing pump 50 and also to the outlets of the filtration units 86 and 88 of the stage 42.

The high pressure pump 102 is able to pump the viscosified water obtained by dilution of the concentrated solution 34 with the processed water of controlled salinity 36 into the injection pipe 30 at a pressure higher or equal to the oil pressure in the oil bearing formation.

A first process of preparing and injecting a viscosified water in an underwater oil bearing formation will be now described.

Initially, the tank 47 is filled with a base fluid 38, containing a concentrated viscosifying polymer. The tank 47 is for example filled above the surface of water and immersed in the body of water 12. Alternatively, the tank 47 is fed batchwise or continuously through the feed pipe 66, directly at the bottom of the body of water 12.

The base fluid 38 is prepared onshore. It consists preferentially of an emulsion, in particular a water-in-oil emulsion, the water phase of the emulsion containing the viscosifying polymer. The mass concentration of polymer in the base fluid 38 is for example comprised between 20% and 70%, preferably between 30% and 60%.

Then, the main feeding pump 50 and the dosing pump 76 are activated. Base fluid 38 is pumped out of the tank 47 at the pressure of the body of water 12 through the distribution pipe 68. Water of controlled salinity obtained from the volume 70 and is injected by the dosing pump 76 into the distribution pipe 68 to dilute the base fluid 38.

The mixing between the processed water of controlled salinity and the base fluid 38, breaks the emulsion to form the concentrated viscosifying solution 34.

The concentrated solution 34 is then pumped through the mixing pump 50. The concentration of polymer in the concentrated solution 34 is for example more than 10 000 ppm and comprised between 5000 ppm and 20000 ppm.

Simultaneously, the pump 90 of the stage 42 is activated to pump source water, here sea water. The source water is pretreated with an oxygen scavenger, and with a antiscalant before its admission in the conveying pump 90.

In reference to FIG. 6, the source water then passes through the raw filtration unit 80, the ultra-filtration unit 82 and splits into the reverse osmosis unit 86 and the nano filtration unit 88 before being mixed again to form a processed water of controlled salinity 36 with a controlled total dissolved ions content, advantageously less than 15% in mass and comprised between 5% in mass and 12% in mass.

In a non limiting example, the concentration of divalent ions in the processed water of controlled salinity 36 is less than 1% in mass and is comprised between 0.1% in mass and 2% in mass.

The concentrated solution 34 is diluted with the processed water of controlled salinity 36 in the mixing device 100, before being pumped by the high pressure pump 102.

A viscosified water 32, having a viscosity comprised between 1 mPa·s and 50 mPa·s, in particular between 2 mPa·s and 40 mPa·s is fed into the injection pipe 30. This viscosified water 32 is sometimes referred to as “smart water”. It has a required rheology and composition.

In a non limiting example, the pressure of the viscosified water 32 is more than 5 bars and is generally comprised between 5 bars and 250 bars.

The viscosified water 32 is then injected in one or more wells 20 through the well head 22, after advantageously passing through a manifold 24.

The viscosified water 32 is injected in the oil bearing formation, at a location where oil is recovered in the formation, to help displacing the oil contained in the formation.

The recovered oil passes through the manifold 24 and is conveyed to the collector 26 and to the riser 28 for transportation to the surface facility.

Thanks to the process according to the invention, the logistics of provision of base material for the viscosified water, in particular polymer and water, is very simple to manage, since these components can be provided directly in the form of a base fluid 38 and stored underwater in a tank 47. No space or very little space is required on the surface facility, which reduces the footprint and the capital costs needed for operating the oil and gas production installation 10.

The viscosified water 32 is advantageously prepared directly in the vicinity of its injection point in the bottom of the body of water 12, which limits the transportation length of this viscosified water 32 and avoids the degradation of the polymer. In a conventional installation in which the viscosified polymer is prepared at the surface, often more than 15% in mass of the polymer degrades between the surface facility and the injection point.

Moreover, the viscosified water 32 being prepared underwater, at a depth at which oxygen content is quite low, the risk of oxygen contamination is low, which prevents degradation of the polymer contained in the viscosified water.

The underwater facility 18 according to the invention greatly reduces the quantity of polymer used during the enhanced recovery process and the associated variable costs.

The oil and gas production installation 10 is therefore operable in an efficient and economically viable manner.

In a variant, shown in FIG. 7, the underwater facility 18 further comprises an additional surfactant providing unit 120, equipped with a dosing pump 122 whose outlet is connected to the inlet of the mixing device 100, downstream of the stage 42 for providing processed water of controlled salinity.

The additional surfactant is mixed with the solution 34 and with the processed water of controlled salinity 36 in the mixing device 100 and it is pumped in the high pressure pump 102 before being introduced in the oil bearing formation.

Such a viscosified water allows enhanced recovery of oils in specific oil bearing formations, such as clastic and carbonate subterranean formations.

In a variant, shown in dotted lines on FIG. 7, the underwater facility 18 further comprises an alkali solution injection unit 128, able to inject a alkali solution 126 to be mixed with the solution 34, with the additional surfactant solution 124 and with the source water solution 36 before the mixing device 100. The alkali solution 126 comprises or consists of for example ammonia.

In the underwater facilities 18 of FIGS. 2 and 7, the preparation of the solution 34 is carried out continuously.

In a variant, shown in FIG. 8, the breaking of the emulsion constituting the base solution 38 is carried out semi-batchwise in a mixing tank 130. The bottom of the mixing tank 130 is then fed to the pump 50.

In another variant, the base fluid 38 is not an emulsion but is a concentrated solution of the viscosifying compound. The process hence does not comprise a step of breaking an emulsion, but rather a dilution step to obtain the concentrated solution.

In the above-described processes, the viscosified water 32 is directly injected into the underwater subterranean formation after it is produced. In a variant, the viscosified water 32 is stored underwater in one or more pressure compensated tanks or one or more pressure fully rated tanks before it is injected.

1. An underwater process of providing a viscosified water (32) for injecting into an underwater subterranean oil bearing formation, the underwater process comprising the following steps, carried out underwater, at the bottom of a body of water:
providing a base fluid (38) comprising at least a viscosifying compound;
obtaining a concentrated viscosifying solution (34) from the base fluid (38);
providing a processed water of controlled salinity (36);
diluting the concentrated viscosifying solution (34) with the processed water of controlled salinity (36) to form the viscosified water (32).

2. The underwater process according to claim 1, wherein the viscosifying compound comprises a polymer and/or a surfactant.

3. The underwater process according to claim 1, wherein the base fluid (38) is provided from above the surface of the body of water (12).

4. The underwater process according to claim 3, wherein the base fluid (38) consists of an emulsion, the preparation step comprising breaking the emulsion at the bottom of the body of water to form the concentrated viscosifying solution (34).

5. The underwater process according to claim 4, wherein breaking the emulsion comprises diluting the base solution.

6. The underwater process according to claim 4, wherein the base fluid (38) consists of a water in oil emulsion, the viscosifying compound being contained in the water phase of the water in oil emulsion.

7. The underwater process according to claim 1, wherein the base fluid (38) consists of a concentrated solution of the viscosifying compound.

8. The underwater process according to claim 1, wherein the step of providing a processed water of controlled salinity (36) comprises generating at the bottom of the body of water a water with controlled ion concentration, in particular controlled divalent ions concentration.

9. The underwater process according to claim 8, wherein the water generation step comprises passing a source water in a disc filtration unit, a hydrocyclone, an ultrafiltration unit (82), a nanofiltration unit (88), and/or a reverse osmosis unit (86).

10. The underwater process according to claim 1, comprising storing a base fluid (38) into a pressure compensated tank (47) and/or a pressure rated tank (47) at the bottom of the body of water, the concentrated viscosifying solution being prepared from the base fluid (38) contained in the tank (47).

11. The underwater process according to claim 1, wherein the diluting step comprises passing the mixture of processed water of controlled salinity (36) and of concentrated viscosifying solution (34) into a mixing device (100).

12. The underwater process according to claim 1, comprising injecting the viscosified water (32) into the underwater subterranean formation.

13. The underwater process according to claim 12, wherein the viscosity of the viscosified water (32) at the injecting step is comprised between 1 mPa·s and 50 mPa·s.

14. A underwater facility (38) providing a viscosified water (32) for injecting into an underwater subterranean oil bearing formation, comprising:
a stage (40) for obtaining a concentrated viscosifying solution (34) from a base fluid (38) comprising at least a viscosifying compound;
a stage (42) for providing a processed water of controlled salinity (36);
a stage (44) for preparing a viscosified water (32), comprising a mixing device (100) for diluting the concentrated viscosifying solution (34) with the processed water of controlled salinity (36) to form the viscosified water (32).

15. The underwater facility (18) according to claim 14, wherein the stage (40) for obtaining a concentrated viscosifying solution (34) comprises a source of a base fluid (38) being an emulsion, and comprising a module (48) for breaking the emulsion located upstream of the mixing device (100).

16. The underwater facility (18) according to claim 14, wherein the stage (40) for obtaining a concentrated viscosifying solution (34) comprises a pressure compensated tank (47) or a pressure rated tank (47) containing a base fluid (38) intended to form the concentrated viscosifying solution (34).

17. The underwater facility (18) according to claim 14, wherein the stage (42) for providing a processed water of controlled salinity (36) comprises a disc filtration unit, a hydrocyclone, a ultra-filtration unit (82), a nanofiltration unit (88) and/or a reverse osmosis unit (86).

18. The underwater facility (18) according to claim 14, comprising a stage for injecting the viscosified water (32) into the underwater subterranean formation.
